(19) United States
(12) Patent Application Publication
(10) Pub. No.: US 2026/0321460 A1
(43) Pub. Date: Oct. 15, 2026

(54) Cable and Data Line

(71) Applicant: GUANGDONG OPSCO TECHNOLOGY CO., LTD, Dongguan (CN)

(72) Inventors: MINGJIAN LIU, Dongguan (CN); GENGSHENG ZHU, Dongguan (CN)

(21) Appl. No.: 19/682,451

(22) Filed: May 20, 2026

Related U.S. Application Data
(63) Continuation of application No. PCT/CN2024/135871, filed on Nov. 29, 2024.

(30) Foreign Application Priority Data
Nov. 27, 2024 (CN) 2024117171415

(51) Int. Cl. H01B 7/36

(52) U.S. Cl. CPC H01B 7/36

(57) ABSTRACT

A cable and a data line, including: a light-emitting adhesive layer having a first accommodating region and a second accommodating region disposed opposite each other; a plurality of transmission lines arranged in the first accommodating region; an insulating base including a first end surface and a second end surface opposite each other, the first end surface facing the transmission lines and disposed in the second accommodating region; a plurality of light-emitting assemblies arranged on the second end surface along the extending direction of the cable, in which light is emitted through the light-emitting adhesive layer and diffusely reflected by the transmission lines to form diffusely reflected light, and the diffusely reflected light is emitted from the second end surface.

This application is a National Stage of International Application No. PCT/CN2024/135871, filed on Nov. 29, 2024, which claims the priority to Chinese Patent Application No. 2024117171415, entitled “Cable and Data Line”, and filed on Nov. 27, 2024, the entire contents of which are incorporated herein by reference.

### TECHNICAL FIELD

The present application relates to the technical field of LED, in particular to a cable and a data line.

### BACKGROUND

With the continuous advancement of science and technology and the increase in people's personalized demands for electronic devices, light-emitting data cables have become increasingly popular in consumer electronic products. Such cables are not only used for data transmission and power supply, but also provide visual aesthetic feeling through built-in light-emitting elements, enhancing the user experience. Traditional cables usually have basic transmission functions and a single appearance design, which cannot meet the modern consumers' demands for product aesthetics and personalization.

At present, although the light-emitting data cables on the market can achieve a certain light-emitting effect, most of them have some technical limitations. For example, the light-emitting elements of many cables can emit light on one side or the light distribution is uneven, resulting in poor light-emitting effect and failure to present an ideal visual effect from all angles. In addition, the design of some cables does not fully consider the problems of energy consumption and heat dissipation, leading to shortened service life and potential safety hazards of the cables.

### SUMMARY OF THE INVENTION

In a first aspect, the present application provides a cable, including:
a light-emitting adhesive layer, in which the light-emitting adhesive layer has a first accommodating region and a second accommodating region disposed opposite each other;
a covering layer, in which the covering layer is disposed on an outer side of the light-emitting adhesive layer, and the covering layer is made of a light-homogenizing material;
a plurality of transmission lines, in which the plurality of transmission lines are arranged at intervals in the first accommodating region of the light-emitting adhesive layer, and each transmission line is either a power line or a communication line;
an insulating base, in which the insulating base includes a first end surface and a second end surface disposed opposite each other, the first end surface faces the transmission lines, and the insulating base is disposed in the second accommodating region;
a plurality of light-emitting assemblies, in which the plurality of light-emitting assemblies are arranged one by one on the second end surface of the insulating base along the extending direction of the cable and are located in the second accommodating region, light emitted by the light-emitting assemblies passes through the light-emitting adhesive layer and the covering layer;
in which, the light emitted by the light-emitting assemblies is diffusely reflected by the transmission lines to form diffusely reflected light, and the diffusely reflected light is emitted through the light-emitting adhesive layer and the covering layer which face the second end surface of the insulating base.

In a second aspect, the present application provides a data line, including the cable provided in any embodiment of the present application and an adapter interface; in which the adapter interface is connected to the transmission lines and the light-emitting assemblies of the cable.

### BRIEF DESCRIPTION OF THE DRAWINGS

In order to explain the technical solutions of the embodiments of the present application more clearly, the drawings needed in the description of the embodiments will be briefly introduced below. Obviously, the drawings described below are some embodiments of the present application, and for those of ordinary skill in the art, other drawings can be obtained according to these drawings without creative work.

FIG. 1 is a structural schematic diagram of a first type of cable provided in an embodiment of the present application;

FIG. 2 is a cross-sectional schematic diagram of the first type of cable provided in an embodiment of the present application;

FIG. 3 is a cross-sectional schematic diagram of a second type of cable provided in an embodiment of the present application;

FIG. 4 is a structural schematic diagram of a light-emitting assembly and an insulating base provided in an embodiment of the present application;

FIG. 5 is a dimension schematic diagram of a cable provided in the present application;

FIG. 6 is a structural schematic diagram of a data line provided in the present application.

Reference Numerals:

100, data line; 10, cable; 11, covering layer; 12, light-emitting adhesive layer; 121, first accommodating region; 122, second accommodating region; 13, transmission line; 14, insulating base; 15, light-emitting assembly; 20, adapter interface.

It should be understood that the above general description and the following detailed description are exemplary and explanatory, and cannot limit the present application.

### DETAILED DESCRIPTION

The technical solutions in the embodiments of the present application will be clearly and completely described below in conjunction with the drawings in the embodiments of the present application. Obviously, the described embodiments are a part of the embodiments of the present application, not all of them. Based on the embodiments in the present application, all other embodiments obtained by those of ordinary skill in the art without creative work fall within the protection scope of the present application.

The flow charts shown in the drawings are exemplary illustrations, which do not need to include all contents and operations/steps, nor do they need to be executed in the described order. For example, some operations/steps can also be decomposed, combined or partially merged, so the actual execution order may be changed according to the actual situation.

It should be understood that the terms used in the specification of the present application are for the purpose of describing specific embodiments and are not intended to limit the present application. As used in the specification and the appended claims of the present application, the singular forms “a”, “an” and “the” are intended to include the plural forms unless the context clearly indicates otherwise.

It should be understood that for the convenience of clearly describing the technical solutions of the embodiments of the present application, words such as “first” and “second” are used in the embodiments of the present application to distinguish the same or similar items with basically the same functions and effects. For example, the first end surface and the second end surface are used to distinguish different end surfaces, and do not limit their order. Those skilled in the art can understand that words such as “first” and “second” do not limit the quantity and execution order, and words such as “first” and “second” do not necessarily mean different.

It should be understood that the term “and/or” used in the specification and the appended claims of the present application refers to any combination and all possible combinations of one or more of the associated listed items, and includes these combinations.

With the continuous advancement of science and technology and the increase in people's personalized demands for electronic devices, light-emitting data cables have become increasingly popular in consumer electronic products. Such cables are not only used for data transmission and power supply, but also provide visual aesthetic feeling through built-in light-emitting elements, enhancing the user experience. Traditional cables usually have basic transmission functions and a single appearance design, which cannot meet the modern consumers' demands for product aesthetics and personalization.

At present, although the light-emitting data cables on the market can achieve a certain light-emitting effect, most of them have some technical limitations. For example, the light-emitting elements of many cables can emit light on one side or the light distribution is uneven, resulting in poor light-emitting effect and failure to present an ideal visual effect from all angles. In addition, the design of some cables does not fully consider the problems of energy consumption and heat dissipation, leading to shortened service life and potential safety hazards of the cables.

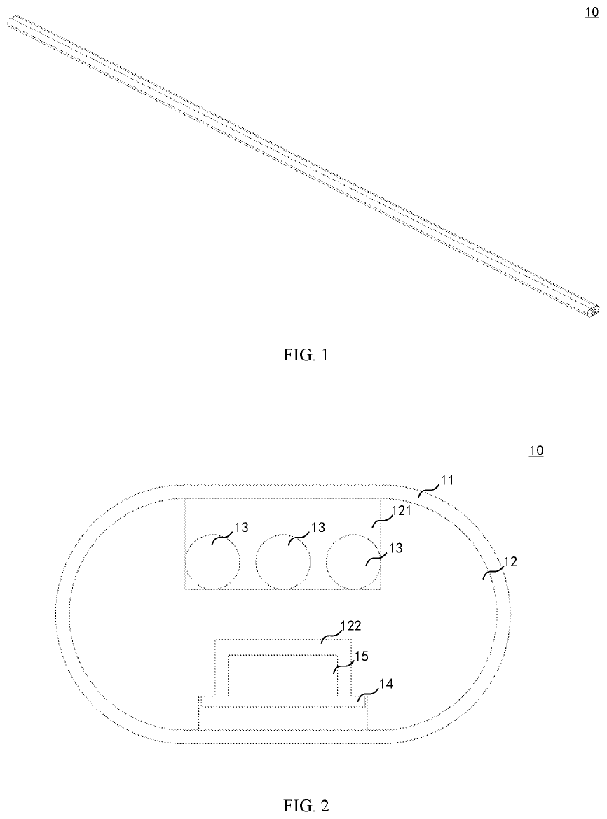

With reference to FIG. 1 to FIG. 5, the present application provides a cable 10, including a light-emitting adhesive layer 12, a covering layer 11, a plurality of transmission lines 13, an insulating base 14 and a plurality of light-emitting assemblies 15. The light-emitting adhesive layer 12 has a first accommodating region 121 and a second accommodating region 122 disposed opposite each other; the covering layer 11 is disposed on the outer side of the light-emitting adhesive layer 12, and the covering layer 11 is made of a light-homogenizing material; the plurality of transmission lines 13 are arranged at intervals in the first accommodating region 121 of the light-emitting adhesive layer 12, and each transmission line 13 is either a power line or a communication line; the insulating base 14 includes a first end surface and a second end surface disposed opposite each other, the first end surface faces the transmission lines 13, and the insulating base 14 is disposed in the second accommodating region 122; the plurality of light-emitting assemblies 15 are arranged one by one on the second end surface of the insulating base 14 along the extending direction of the cable 10 and are located in the second accommodating region 122, light emitted by the light-emitting assemblies 15 passes through the light-emitting adhesive layer 12 and the covering layer 11; in which, the light emitted by the light-emitting assemblies 15 is diffusely reflected by the transmission lines 13 to form diffusely reflected light, and the diffusely reflected light passes through the light-emitting adhesive layer 12 and the covering layer 11 which face the second end surface of the insulating base 14.

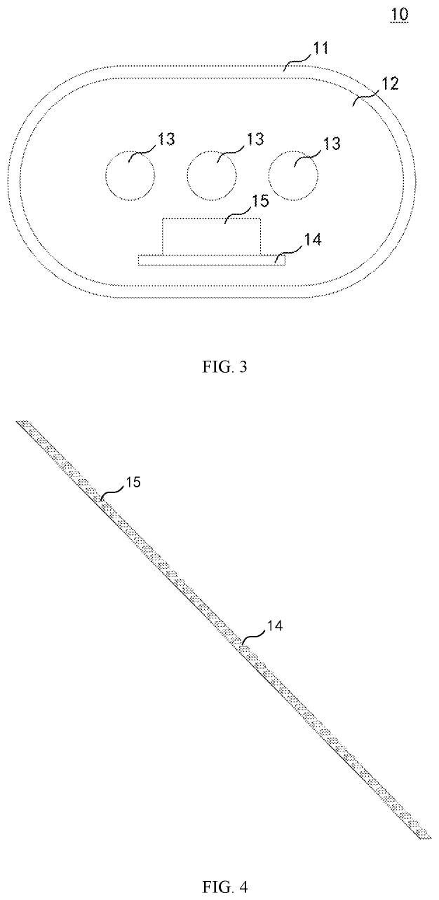

In some embodiments, the light-emitting adhesive layer 12 is the foundation of the entire light-emitting system of the cable 10, and it is internally divided into two areas: a first accommodating region 121 and a second accommodating region 122 (as shown in FIG. 3, the first accommodating region 121 and the second accommodating region 122 are completely attached to the transmission line 13 and the light-emitting assembly 15 respectively, so they are not marked to avoid confusion). A light-emitting material is embedded in the light-emitting adhesive layer 12, which can evenly scatter the light of the light-emitting assemblies 15 to the entire surface of the cable 10, enabling the cable 10 to achieve high-brightness light emission without dead angles in 360 degrees. The covering layer 11 is made of a light-homogenizing material, which can further evenly distribute light and enhance the overall visual effect. The covering layer 11 is disposed on the outer side of the light-emitting adhesive layer 12, which can not only protect the internal structure, but also ensure the uniform distribution of light and avoid the phenomenon of uneven light. The transmission lines 13 include power lines and communication lines, and these cables 10 are arranged at intervals in the first accommodating region 121 of the light-emitting adhesive layer 12. The transmission lines 13 not only carry the transmission of power or data signals, but also can conduct diffuse reflection of light through their surfaces to enhance the light-emitting effect.

The insulating base 14 includes a first end surface and a second end surface disposed opposite each other, in which the first end surface faces the transmission lines 13. The insulating base 14 is disposed in the second accommodating region 122 of the light-emitting adhesive layer 12, and its main function is to fix and isolate the light-emitting assemblies 15 to ensure the working stability and safety of the light-emitting assemblies 15.

The plurality of light-emitting assemblies 15 are arranged one by one on the second end surface of the insulating base 14 along the extending direction of the cable 10 and are located in the second accommodating region 122. After the light-emitting assemblies 15 emit light, the light is first scattered through the light-emitting adhesive layer 12, then further evenly distributed through the covering layer 11, and finally a high-brightness light-emitting effect without dead angles in 360 degrees is achieved. In addition, the light emitted by the light-emitting assemblies 15 can also be diffusely reflected by the transmission lines 13 to enhance the overall light-emitting effect.

In some embodiments, as shown in FIG. 2, the transmission lines 13 are partially wrapped in the light-emitting adhesive layer 12.

The partial wrapping of the transmission lines 13 in the light-emitting adhesive layer 12 can enhance the light diffuse reflection effect, because the surfaces of the transmission lines 13 can be used as a diffuse reflection medium to help evenly scatter the light emitted by the light-emitting assemblies 15 to all directions of the cable 10. This design enables light to be evenly distributed not only between the light-emitting adhesive layer 12 and the covering layer 11, but also further enhances the diffuse reflection effect through the surfaces of the transmission lines 13, improving the uniformity and brightness of light.

At the same time, the partial wrapping design allows part of the light to propagate directly through the light-emitting adhesive layer 12, and the other part to be diffusely reflected through the surfaces of the transmission lines 13, thus making full use of each beam of light. In this way, light is utilized more efficiently, reducing the energy consumption of the light-emitting assemblies 15 and enhancing the light-emitting effect at the same time.

Correspondingly, the light-emitting adhesive layer 12 plays a certain protective role for the transmission lines 13, preventing the wear and aging of the transmission lines 13 in the external environment. This not only prolongs the service life of the transmission lines 13, but also improves the overall durability of the cable 10, making the cable 10 maintain good transmission performance during long-term use. Moreover, the partial wrapping of the transmission lines 13 in the light-emitting adhesive layer 12 can optimize the propagation path of light in the adhesive layer, making the light more evenly distributed in the adhesive layer. This design reduces the loss of light during propagation, ensures that light is emitted evenly from all parts of the cable 10, and further improves the uniformity of the light-emitting effect.

The partial wrapping of the transmission lines 13 in the light-emitting adhesive layer 12 can reduce the light directly emitted by the light-emitting assemblies 15 to the transmission lines 13, avoiding excessive concentration of light in some parts. This design makes the light distribution in the light-emitting adhesive layer 12 more uniform, avoids over-bright or dark areas in some regions, and improves the overall visual effect.

In summary, the design of partially wrapping the transmission lines 13 in the light-emitting adhesive layer 12 improves the light-emitting effect and service life of the cable 10 in many aspects by enhancing the diffuse reflection effect of light, improving the light utilization rate, protecting the transmission lines 13, optimizing the light propagation path, reducing the uneven phenomenon caused by direct light emission and enhancing the overall aesthetics of the cable 10, and also improves the safety and reliability of the cable 10. This design innovation not only solves the limitations of the traditional light-emitting data line 100, but also improves the appearance quality of the cable 10, and makes the cable 10 smoother in the use process, improving the user's use experience and providing a better product experience for users.

In some embodiments, as shown in FIG. 3, the transmission lines 13 are completely wrapped in the light-emitting adhesive layer 12.

With the transmission lines 13 completely wrapped in the light-emitting adhesive layer 12, the light-emitting adhesive layer 12 can completely cover the transmission lines 13, making the propagation of light in the adhesive layer more uniform. This design can reduce the direct reflection of light on the surfaces of the transmission lines 13, make the light more fully scattered in the adhesive layer, thus achieving a more uniform light-emitting effect and avoiding the problem of over-bright or dark areas in some regions.

At the same time, with the transmission lines 13 completely wrapped in the light-emitting adhesive layer 12, the light in the light-emitting adhesive layer 12 can propagate in a wider range through multiple diffuse reflections. Multiple diffuse reflections can further improve the uniformity and brightness of light, enabling the cable 10 to present an ideal visual effect from all angles.

Correspondingly, the full wrapping design makes the transmission lines 13 completely protected by the light-emitting adhesive layer 12, reducing the direct impact and wear of the external environment on the transmission lines 13. This design can significantly prolong the service life of the transmission lines 13, improve the overall durability of the cable 10, and ensure that the cable 10 maintains good transmission performance during long-term use. At the same time, although the transmission lines 13 are fully wrapped, the air circulation inside the light-emitting adhesive layer 12 and the thermal conductivity of the material can effectively help heat dissipation. This design can reduce faults and potential safety hazards caused by overheating, ensuring that the cable 10 remains safe and reliable even when used at high power. The full wrapping design avoids direct contact between the transmission lines 13 and the light-emitting assemblies 15, reducing the possibility of electromagnetic interference and light interference. It can improve the stability and reliability of data transmission, ensure that the light-emitting effect is not interfered by the transmission lines 13, and make the cable 10 more perfect in function. Finally, the full wrapping design makes it easier to control the combination of the light-emitting adhesive layer 12 and the transmission lines 13 in the production process, reducing the manufacturing difficulty and cost. This design can reduce production costs, improve production efficiency, and make the cable 10 easier to mass produce to meet market demand.

In summary, the design of completely wrapping the transmission lines 13 in the light-emitting adhesive layer 12 improves the light-emitting effect and service life of the cable 10 in many aspects by achieving more uniform light distribution, enhanced light diffuse reflection, better protective performance, improved heat dissipation performance, reduced interference of internal structures and simplified manufacturing process, and also improves the safety and reliability of the cable 10. This design not only solves the limitations of the traditional light-emitting data line 100, but also provides a more stable and beautiful product experience for users.

In some embodiments, as shown in FIG. 2, the insulating base 14 together with the pins and the light-emitting assemblies 15 disposed on the insulating base 14 is partially wrapped in the light-emitting adhesive layer 12.

With the insulating base 14 partially wrapped in the light-emitting adhesive layer 12, the light-emitting adhesive layer 12 can cover the light-emitting assemblies 15 and the pins more evenly, making the light scatter more evenly when propagating in the adhesive layer. It reduces the concentration of light in some parts, avoids the phenomenon of uneven light emission, and thus achieves a more uniform 360-degree dead-angle-free light emission effect. The material of the surfaces of the insulating base 14 and the pins can be used as a diffuse reflection medium for light, and through the partial wrapping design, light is reflected multiple times on these surfaces and in the light-emitting adhesive layer 12. Multiple diffuse reflections can further improve the brightness and uniformity of light, enabling the cable 10 to present an ideal visual effect from all angles.

The design of partially wrapping the insulating base 14 together with the pins and the light-emitting assemblies 15 disposed on the insulating base 14 in the light-emitting adhesive layer 12 improves the light-emitting effect and service life of the cable 10 in many aspects by achieving uniform light distribution, enhanced diffuse reflection effect, better protective performance, reduced external interference, optimized heat dissipation performance, enhanced overall aesthetics of the cable 10 and convenient installation and maintenance. This design not only solves the limitations of the traditional light-emitting data line 100, but also provides a more stable, beautiful and safe product experience for users.

In some embodiments, as shown in FIG. 3, the insulating base 14 together with the pins and the light-emitting assemblies 15 disposed on the insulating base 14 is completely wrapped in the light-emitting adhesive layer 12.

First of all, the full wrapping design makes the light-emitting adhesive layer 12 completely cover the insulating base 14, the pins and the light-emitting assemblies 15, making the light scatter more evenly when propagating in the adhesive layer. This design reduces the concentration of light in some parts, avoids the generation of light spots and dark areas, and achieves a more uniform light-emitting effect.

Then, the light-emitting adhesive layer 12 completely wraps the insulating base 14 and the light-emitting assemblies 15, and light is reflected multiple times in the adhesive layer and on the surface of the insulating base 14, enhancing the diffuse reflection effect. Multiple diffuse reflections can further improve the brightness and uniformity of light, enabling the cable 10 to present an ideal visual effect from all angles.

Furthermore, the full wrapping design completely encloses the insulating base 14, the pins and the light-emitting assemblies 15 in the light-emitting adhesive layer 12, protecting them from the influence of the external environment such as dust, moisture, corrosion and so on. This design significantly prolongs the service life of the light-emitting assemblies 15 and the pins, improves the overall durability and reliability of the cable 10, and ensures the stability and reliability of the light-emitting effect during long-term use.

Further, due to the isolation of external environmental interference by the full wrapping design, the cable 10 can be used in harsher environments such as humid and high-dust environments. This design enhances the environmental adaptability of the cable 10 and ensures its performance and safety under various use conditions. At the same time, the light-emitting adhesive layer 12 has good waterproof and dustproof performance, and the full wrapping design can completely seal the insulating base 14, the pins and the light-emitting assemblies 15. This design makes the cable 10 maintain a good working state even in humid or dusty environments, reducing faults caused by water or dust.

Furthermore, the light-emitting adhesive layer 12 completely wraps the insulating base 14 and the light-emitting assemblies 15, which can form a closed light propagation path inside and reduce the loss of light. This design ensures the efficient propagation of light in the adhesive layer, improves the light-emitting efficiency and reduces the energy consumption of the light-emitting assemblies 15. The full wrapping design makes the insulating base 14, the pins, the light-emitting assemblies 15 and the light-emitting adhesive layer 12 integrate into one, with a smoother and neater appearance. This design not only improves the appearance quality of the cable 10, but also makes the cable 10 smoother in the use process, improving the user's use experience.

Finally, the light-emitting adhesive layer 12 can play a certain electromagnetic shielding role, and the full wrapping design reduces the direct contact between the pins, the light-emitting assemblies 15 and the outside, thereby reducing electromagnetic interference. This design improves the stability and reliability of data transmission and avoids data transmission problems caused by electromagnetic interference.

In summary, the design of completely wrapping the insulating base 14 together with the pins and the light-emitting assemblies 15 disposed on the insulating base 14 in the light-emitting adhesive layer 12 improves the light-emitting effect and service life of the cable 10 in many aspects by achieving more uniform light distribution, enhanced light diffuse reflection, comprehensive protective performance, improved environmental adaptability, enhanced waterproof and dustproof performance, optimized light propagation path, enhanced overall aesthetics of the cable 10 and reduced electromagnetic interference. This design not only solves the limitations of the traditional light-emitting data line 100, but also provides a more stable, beautiful and safe product experience for users.

It should be noted that the scheme in FIG. 2 can be realized by first extruding the light-emitting adhesive layer 12 with a preset size, and then installing the light-emitting assemblies 15, the insulating base 14 and the transmission lines 13, while the scheme in FIG. 3 is realized by first placing the light-emitting assemblies 15, the insulating base 14 and the transmission lines 13 and then extruding the fully wrapped light-emitting adhesive layer 12. The light-emitting adhesive layer 12 can be made by any method such as extrusion and molding.

In some embodiments, a projected shape of the first accommodating region 121 on the cross-section of the cable 10 is any one of a circle, a rectangle, an ellipse, a trapezoid, a triangle and a rhombus; and/or a projected shape of the second accommodating region 122 on the cross-section of the cable 10 is any one of a circle, a rectangle, an ellipse, a trapezoid, a triangle and a rhombus; in which the cross-section is a plane perpendicular to the extending direction of the cable 10.

Different cross-sectional shapes provide more options for the design of the cable 10. Designers can select the most suitable shape according to actual demands and application scenarios, thereby optimizing the performance and aesthetics of the cable 10. Different shapes of the first accommodating region 121 and the second accommodating region 122 can affect the propagation path and mode of light in the adhesive layer. By selecting a specific shape, a more uniform light distribution can be achieved, light spots and dark areas can be reduced, and the light-emitting effect can be improved. For example, a circle or an ellipse can disperse light better, while a rectangle or a rhombus may be suitable for specific lighting demands.

At the same time, different shapes of the accommodating regions can change the internal structure of the cable 10, thereby affecting its mechanical properties. Selecting an appropriate shape can enhance the structural strength of the cable 10 and reduce damage caused by external forces. For example, a trapezoidal or triangular shape can provide better rigidity and bending resistance. Different shapes of the accommodating regions can affect the heat dissipation path inside the cable 10. Some shapes (such as a rectangle or a trapezoid) can increase the heat dissipation area and improve the heat dissipation efficiency, thereby reducing the internal temperature, prolonging the service life of the cable 10 and improving safety.

Correspondingly, different cross-sectional shapes can endow the cable 10 with different appearance designs. This design can provide a variety of appearance options according to users' demands and aesthetic preferences, making the cable 10 more diversified and beautiful. For example, a cable 10 with a circular or elliptical shape looks more round and smooth, while a cable 10 with a rhombic or trapezoidal shape is more modern and technological. In addition, different shapes of the first accommodating region 121 and the second accommodating region 122 can affect the bending radius and flexibility of the cable 10. Selecting an appropriate shape can make the cable 10 more flexible during installation and use, reducing damage caused by excessive bending. At the same time, some shapes may be more convenient for users to identify and locate, improving the convenience of installation and maintenance.

Different cross-sectional shapes can adapt to various use environments and scenarios. For example, a circular cable 10 is suitable for scenarios that require frequent movement and bending, while a rectangular or trapezoidal cable 10 may be more suitable for fixed installation and environments with limited space. This design enables the cable 10 to better meet diversified application demands.

In the above extended embodiments of the cable 10, the projected shapes of the first accommodating region 121 and the second accommodating region 122 can be any one of a circle, a rectangle, an ellipse, a trapezoid, a triangle and a rhombus. This design improves the performance and user experience of the cable 10 in many aspects by improving design flexibility, optimizing light propagation, improving structural strength, enhancing heat dissipation performance, enhancing aesthetics, improving installation and maintenance experience and adapting to different use scenarios. This diversified shape selection not only meets different functional demands, but also provides more creative space for the design of the cable 10.

In some embodiments, as shown in FIG. 3, a projected shape of the first accommodating region 121 on the cross-section of the cable 10 is the same as a projected shape of the transmission lines 13 relative to the cross-section.

The same projected shape of the first accommodating region 121 and the transmission lines 13 can make the layout of the light-emitting assemblies 15 and the transmission lines 13 on the cross-section more compact and reasonable. This helps to reduce the overall thickness and volume of the cable 10, making the cable 10 lighter and more flexible, and convenient for installation and use. The same projected shape makes the spatial layout of the light-emitting assemblies 15 and the transmission lines 13 more symmetrical and consistent, and the propagation path of light in the adhesive layer more optimized. This can reduce the loss of light during propagation, improve the uniformity and brightness of light, and thus achieve a better light-emitting effect.

At the same time, the same projected shape can make the structure of the first accommodating region 121 and the transmission lines 13 more coordinated and stable. This design helps to improve the overall structural strength of the cable 10, reduce damage caused by external forces or bending, and prolong the service life of the cable 10. The same shape of the first accommodating region 121 and the transmission lines 13 can make the heat distribution on the cross-section more uniform. This helps to improve the heat dissipation efficiency, prevent local overheating, thereby protecting the light-emitting assemblies 15 and the transmission lines 13, and ensuring the stability and safety of the cable 10.

In summary, in the above embodiments of the cable 10, by making the projected shape of the first accommodating region 121 on the cross-section of the cable 10 the same as the projected shape of the transmission lines 13 relative to the cross-section, this design improves the performance and user experience of the cable 10 in many aspects by improving space utilization, optimizing the light propagation path, enhancing structural strength, achieving uniform heat distribution, enhancing aesthetics, simplifying the production process, improving installation and maintenance experience and adapting to specific use scenarios. This consistent shape design not only meets functional demands, but also provides convenience and optimization for the production and manufacture and user use of the cable 10.

In some embodiments, the plurality of transmission lines 13 are arranged at equal intervals in the first accommodating region 121. In the above design of the cable 10, arranging the plurality of transmission lines 13 at equal intervals in the first accommodating region 121 has the advantages of improving the stability of signal transmission, optimizing the internal structure of the cable 10, achieving uniform heat distribution, improving the repeatability of the manufacturing process, enhancing the appearance aesthetics, improving space utilization, facilitating maintenance and detection and reducing manufacturing defects. This design not only improves the performance of the cable 10 in terms of functionality, but also provides more convenience and optimization in the manufacturing and use processes.

In some embodiments, as shown in FIG. 3, the first accommodating region 121 includes a plurality of first sub-accommodating regions (the areas where the circular transmission lines 13 are placed in FIG. 3, not marked to avoid confusion), and each first sub-accommodating region is configured to place one transmission line 13. The design of the first accommodating region 121 including a plurality of first sub-accommodating regions with each for placing one transmission line 13 can improve the stability of signal transmission, optimize the internal structure, achieve uniform heat distribution, facilitate manufacturing and assembly, enhance the appearance aesthetics, improve space utilization, facilitate maintenance and detection, reduce manufacturing defects and adapt to the demands of different transmission lines 13. This refined design not only improves the performance of the cable 10 in terms of functionality, but also provides more convenience and optimization in the production, use and maintenance processes.

In some embodiments, as shown in FIG. 2, the second accommodating region 122 includes a second sub-accommodating region and a third sub-accommodating region (the areas where the insulating base 14 and the light-emitting assembly 15 are placed in FIG. 2 respectively, not marked to avoid confusion), the second sub-accommodating region is in communication with the third sub-accommodating region, the insulating base 14 is disposed in the second sub-accommodating region, and the light-emitting assemblies 15 on the insulating base 14 are disposed in the third sub-accommodating region.

The second accommodating region 122 includes a second sub-accommodating region and a third sub-accommodating region which are in communication with each other, the insulating base 14 is disposed in the second sub-accommodating region, and the light-emitting assemblies 15 are disposed in the third sub-accommodating region. This design can improve electrical safety, optimize the signal transmission path, enhance structural stability, facilitate manufacturing and assembly, improve the heat dissipation effect, enhance the convenience of maintenance and detection, enhance the appearance aesthetics, adapt to different functional demands and simplify design and debugging. This separated and optimized design not only improves the performance of the cable 10 in terms of functionality, but also provides more convenience and optimization in the production, use and maintenance processes.

In some embodiments, an area of a projected shape of the second sub-accommodating region on the cross-section of the cable 10 is greater than or equal to an area of a projected shape of the insulating base 14 on the cross-section of the cable 10; an area of a projected shape of the third sub-accommodating region on the cross-section of the cable 10 is greater than or equal to an area of a projected shape of the light-emitting assemblies 15 on the cross-section of the cable 10.

An area of a projected shape of the second sub-accommodating region on the cross-section of the cable 10 is greater than or equal to an area of a projected shape of the insulating base 14 on the cross-section of the cable 10; an area of a projected shape of the third sub-accommodating region on the cross-section of the cable 10 is greater than or equal to an area of a projected shape of the light-emitting assemblies 15 on the cross-section of the cable 10.

In some embodiments, as shown in FIG. 2, a distance between the light-emitting assemblies 15 and the light-emitting adhesive layer 12 is a preset distance. The smaller the preset distance is, the more light-emitting assemblies 15 are provided per meter of the cable 10. The preset distance can ensure that the light emitted by the light-emitting assemblies 15 can be evenly diffused and distributed when reaching the light-emitting adhesive layer 12. This design helps to improve the uniformity and brightness of light, making the cable 10 more beautiful and efficient when emitting light. At the same time, the preset distance can provide a certain protective buffer for the light-emitting assemblies 15, avoiding mechanical damage that may be caused by direct contact with the light-emitting adhesive layer 12. This design prolongs the service life of the light-emitting assemblies 15 and improves the reliability and durability of the cable 10.

Correspondingly, the preset distance can reduce the direct conduction of heat generated by the light-emitting assemblies 15 to the light-emitting adhesive layer 12, preventing the light-emitting adhesive layer 12 from aging or deteriorating due to overheating. This design helps to improve the overall heat dissipation effect of the cable 10 and ensure the long-term stability and performance of the light-emitting adhesive layer 12. It can also ensure a certain insulation distance between the light-emitting assemblies 15 and the light-emitting adhesive layer 12 to prevent electrical short circuit. It improves the electrical safety of the cable 10, reduces potential safety hazards and ensures the safety of users' use. It can also reduce the mutual interference between the light-emitting assemblies 15 and the transmission lines 13, ensuring the stability and reliability of signal transmission. It helps to improve the quality of signal transmission, reduce electromagnetic interference and signal crosstalk, and improve the performance of the cable 10. And it provides a clear reference standard for production and assembly, simplifying the process flow. It improves manufacturing efficiency, reduces assembly difficulty and ensures the position consistency and accuracy of each component.

At the same time, the smaller the preset distance is, the more directly the light emitted by the light-emitting assemblies 15 can enter the light-emitting adhesive layer 12, reducing the loss of light in air or other media and improving the propagation efficiency of light. This means that each light-emitting assembly 15 can illuminate its surrounding area more effectively, so the spacing between each light-emitting assembly 15 can be reduced and the number of light-emitting assemblies 15 can be increased with the same length of the cable 10.

At the same time, the smaller the preset distance is, the easier the light after diffuse reflection by the transmission lines 13 can reach the second end surface of the insulating base 14, thus re-entering the light-emitting adhesive layer 12 and the covering layer 11. Such multiple diffuse reflections can enhance the overall light-emitting effect of the cable 10 and make the light distribution more uniform. Therefore, the spacing between each light-emitting assembly 15 can be set smaller, thus increasing the number of light-emitting assemblies 15 with the same length of the cable 10. The smaller the preset distance is, the shorter the propagation path of the light emitted by the light-emitting assemblies 15 after entering the light-emitting adhesive layer 12 is. This reduces the attenuation of light during propagation, making the light of each light-emitting assembly 15 more concentrated and illuminating its nearby area more effectively. Therefore, to achieve the same light-emitting effect, more light-emitting assemblies can be arranged on the cable 10 of the same length. The smaller the preset distance is, the more compact the assembly between the light-emitting assemblies 15 and the light-emitting adhesive layer 12 is, which can save space inside the cable 10. In this way, more light-emitting assemblies 15 can be accommodated in the cable 10 of the same length, thus improving the light-emitting density of the cable 10. In addition, the reduced spacing between the light-emitting assemblies 15 can simplify the manufacturing process, reduce the use of materials and lower the cost.

In some embodiments, the preset distance is from 1 to 30 mm, which can be specifically adjusted according to the actual product demands.

In some embodiments, if the preset distance is a first distance, the number of the light-emitting assemblies 15 per meter of the cable 10 is greater than a first preset number; and/or if the preset distance is a second distance, the number of the light-emitting assemblies 15 per meter of the cable 10 is greater than a second preset number; and/or if the preset distance is a third distance, a predetermined relationship exists between the number of the light-emitting assemblies 15 and the length of the cable 10; in which the first distance is smaller than the second distance, the second distance is smaller than the third distance, the first preset number is greater than the second preset number, and the second preset number is greater than the third preset number. Thus, the present application can quickly determine the density of the light-emitting assemblies 15 for each installation form.

It should be noted that in some embodiments, the first distance is from 1 to 10 mm, and the first preset number is 100; the second distance is from 10 to 13 mm, and the second preset number is 80; the third distance is from 13 to 30 mm, and the third preset number is 50. The lamp bead density in various cases within 1 to 30 mm can be clearly determined.

In some embodiments, the covering layer 11 includes a light-homogenizing tube, which is sleeved on the outer side of the light-emitting adhesive layer, or wrapped on the outer side of the light-emitting adhesive layer through an injection molding process. The light-homogenizing tube can effectively scatter and evenly distribute the light emitted by the light-emitting assemblies 15, making the light-emitting effect of the entire cable 10 more uniform and soft. It improves the light-emitting efficiency and aesthetics of the cable 10, and users can see more uniform light, reducing glare.

In some embodiments, the covering layer 11 includes a braided sleeve (the exposed part of the cable 10 shown in FIG. 6 is a braided sleeve), which is wrapped on the outer side of the light-emitting adhesive layer. The braided sleeve can provide additional physical protection for the light-emitting assemblies 15 and the light-emitting adhesive layer, preventing damage to the light-emitting assemblies 15 and the light-emitting adhesive layer from the external environment (such as scratching, impact and so on). It prolongs the service life of the cable 10 and improves the durability and reliability of the cable 10.

At the same time, the use of a light-homogenizing tube or a braided sleeve can all improve the uniformity and brightness of light, protect the light-emitting assemblies 15 and the light-emitting adhesive layer, enhance the flexibility of the cable 10, improve the electrical safety of the cable 10, improve the heat dissipation effect, simplify the manufacturing process, enhance the mechanical strength of the cable 10, improve the waterproof and dustproof performance of the cable 10, improve the convenience of maintenance and detection, enhance the appearance aesthetics and adapt to different application scenarios. These optimizations not only improve the functionality and performance of the cable 10, but also provide more convenience and optimization in the production, use and maintenance processes.

In some embodiments, the number of the transmission lines 13 is from 2 to 8, which can be arbitrarily selected and combined according to the type and demand of the data line 100. The type of the data line 100 can be any type, such as any one of USB, TYPE-C, Lightning, HDMI, DisplayPort, Thunderbolt and DVI.

In some embodiments, at least one light-emitting assembly 15 is disposed on the second end surface of the insulating base 14, and light emitted by the light-emitting assemblies 15 on the second end surface passes through the light-emitting adhesive layer 12 and the covering layer 11 which faces the second end surface of the insulating base 14. Since the light effect may be dark on the second end surface of the insulating base 14 (the surface facing away from the transmission lines 13 in FIG. 2), disposing at least one light-emitting assembly 15 on the second end surface according to the actual light effect can improve the overall brightness of the cable 10. At this time, a better overall light-emitting effect can also be achieved even if the insulating base 14 is made of an opaque material.

In some embodiments, a light transmittance of the insulating base 14 is greater than a preset light transmittance. Making the insulating base 14 of a transparent material can enable light to be directly emitted from the light-emitting surface opposite to the second end surface through the insulating base 14, so as to improve the overall light-emitting brightness of the cable 10.

In some embodiments, a material of the insulating base 14 is any one of sapphire, glass, polyimide film and polyethylene terephthalate film, which is specifically selected according to actual cost and demands.

In some embodiments, each of the light-emitting assemblies 15 includes a pin (not shown), which is disposed on the insulating base 14; at least one light-emitting chip (such as a common RGB light-emitting chip, specifically selected according to actual demands), which is disposed on the pin and connected to the pin; a driving chip (such as a common driving IC), which is disposed on the pin, respectively connected to the light-emitting chip and the pin, and configured to control the light-emitting chip to emit light; a packaging adhesive (such as a common transparent adhesive), which surrounds and encapsulates the light-emitting chip and the driving chip.

Disposing the pins on the insulating base 14 can effectively isolate the pins and prevent short circuits or other electrical faults, thereby improving the overall reliability and stability of the cable 10. Encapsulating the outside of the light-emitting chip and the driving chip with the packaging adhesive can protect these sensitive components from the influence of environmental factors (such as moisture, dust, mechanical impact and so on), further enhancing the durability and stability of the cable 10. The driving chip is respectively connected to the light-emitting chip and the pin for controlling the light emission of the light-emitting chip. This design can accurately adjust the light intensity, color and mode, improving the light-emitting efficiency and control flexibility. Disposing the light-emitting chip on the pin ensures the stability and high efficiency of the electrical connection, enabling the light-emitting chip to emit light stably and efficiently. Each light-emitting assembly 15 includes an independent pin, light-emitting chip and driving chip, and this modular design makes the assembly of the cable 10 simpler and more efficient. If a certain component fails, the corresponding module needs to be replaced instead of the entire cable 10, simplifying the maintenance process. The arrangement of the pins on the insulating base 14 makes the connection between various components more neat and orderly, facilitating inspection and maintenance. At the same time, through the control of the driving chip, diversified light-emitting effects (such as static, dynamic, gradient and so on) can be achieved, enhancing the user experience and visual attraction.

In some embodiments, the cable further includes at least one light-emitting cluster, in which each light-emitting cluster includes one or more light-emitting assemblies 15; in which the one or more light-emitting assemblies 15 in each light-emitting cluster are configured to share a common driving chip.

A plurality of light-emitting assemblies 15 (such as LED lamps) are divided into several light-emitting clusters, and the number of light-emitting assemblies 15 in each cluster can be adjusted according to actual demands and the length of the cable 10. One driving chip is configured in each light-emitting cluster, and the driving chip is responsible for controlling the light-emitting state of all light-emitting assemblies 15 in the cluster, including brightness, color temperature, flicker frequency and so on. Each driving chip is connected to the power line and the control line in the cable 10 through leads or wires to ensure that the driving chip can receive power and control signals. The light-emitting assemblies 15 in the cluster are connected to the driving chip through internal wires to form a local control network. The light-emitting assemblies 15 and the driving chip in the cluster are packaged in the insulating base 14 together, and the insulating base 14 can be made of plastic or other insulating materials to ensure electrical safety and mechanical protection.

When one or more light-emitting assemblies 15 in each light-emitting cluster are configured to share a common driving chip, the cable can achieve more accurate and unified control. It makes the light-emitting effect of the cable 10 more consistent at different positions, avoiding the problem of inconsistent control that may occur between multiple independent driving chips.

Sharing the driving chip reduces the number of required driving chips and the complexity of the control circuit. It simplifies the circuit design, reduces the manufacturing cost and improves the production efficiency. When one or more the light-emitting assemblies 15 in each cluster are configured to share a common driving chip, the mutual interference and fault points between independent driving chips can be reduce. It improves the overall reliability of the cable 10 and reduces the risk of failure of the entire cable 10 caused by the failure of the driving chip.

At the same time, sharing the driving chip makes it easier to perform local control and debugging. It makes the cable 10 more flexible in different application scenarios, and the light-emitting state of each cluster can be adjusted as needed.

It also enables the cable 10 to support a variety of control modes, such as lighting one by one, segmental lighting or overall lighting, increasing the functionality and application scenarios of the cable 10. Through accurate control and consistent light-emitting effect, the overall light-emitting effect of the cable 10 is more beautiful and coordinated. It improves the visual effect of the cable 10, making it more in line with users' aesthetic demands and enhancing the attractiveness of the product.

In summary, in the above design of the cable 10, dividing the light-emitting assemblies 15 into a plurality of light-emitting clusters and having the light-emitting assemblies 15 in each cluster configured to share a common driving chip can improve control accuracy, reduce circuit complexity, improve reliability, optimize heat dissipation performance, improve electrical safety, enhance flexibility, save space, improve the convenience of maintenance and detection, support a variety of control modes and enhance aesthetics. This modular design is not only functional.

In some embodiments, a ratio of a width of a projected shape of the insulating base 14 on the cross-section of the cable 10 to a width of a projected shape of the light-emitting assembly 15 on the cross-section of the cable 10 falls within a preset range, and the preset range is from 1 to 1.2.

The width of the insulating base 14 being slightly greater than or equal to the width of the light-emitting assemblies 15 can ensure a sufficient insulation distance between the light-emitting assemblies 15 and external conductive substances. This design effectively prevents the risk of electrical short circuit, improves the electrical safety of the cable 10 and ensures the safety of users' use.

The ratio falling within the range of 1 to 1.2 means that the widths of the insulating base 14 and the light-emitting assemblies 15 are properly matched without excessive waste of space. It makes the entire cable 10 more compact, saves space and is convenient for arrangement and installation in a narrow space.

The insulating base 14 being slightly wider than or equal to the light-emitting assemblies 15 can also provide a certain heat dissipation path to help evenly dissipate the heat generated by the light-emitting assemblies 15. It prevents local overheating, protects the light-emitting assemblies 15 and prolongs the service life of the cable 10. An appropriate width ratio can ensure the stable relative position between the insulating base 14 and the light-emitting assemblies 15, reducing component displacement caused by external forces or bending. It improves the overall structural strength of the cable 10, making it more stable and reliable in various use environments.

In the above design of the cable 10, the ratio of the width of the projected shape of the insulating base 14 on the cross-section of the cable 10 to the width of the projected shape of the light-emitting assembly 15 on the cross-section of the cable 10 falling within the preset range (1 to 1.2) can improve electrical safety, optimize space utilization, improve heat dissipation effect, enhance structural stability, facilitate manufacturing and assembly, improve the convenience of maintenance and detection, enhance appearance aesthetics, reduce manufacturing defects, improve the flexibility of design and debugging, adapt to various environments and reduce electromagnetic interference. This precise design not only improves the performance of the cable 10 in terms of functionality, but also provides more convenience and optimization in the production, use and maintenance processes.

In some embodiments, the plurality of light-emitting assemblies 15 are arranged at equal intervals on the insulating base 14. Arranging the plurality of light-emitting assemblies 15 at equal intervals on the insulating base 14 can bring uniform lighting effect, reduce visual fatigue, improve design consistency, simplify the manufacturing process, improve heat dissipation performance, enhance structural stability, facilitate maintenance and detection, improve the convenience of installation and use, enhance the consistency of visual effect, improve the flexibility of layout and reduce electromagnetic interference. This layout not only improves the functionality and performance of the cable 10, but also provides more convenience and optimization in the production, use and maintenance processes, meeting users' demands for high-quality light-emitting cables 10.

In some embodiments, a distance between adjacent transmission lines 13 is from 1 mm to 3 mm; and/or a diameter of the cable 10 is from 0.3 mm to 1 mm; and/or a distance between the light-emitting assemblies 15 and the transmission lines 13 is from 1 to 2.5 mm; and/or a length of a projected shape of the light-emitting assemblies 15 on the cross-section of the cable 10 is from 0.1 mm to 3 mm; and/or a width of a projected shape of the light-emitting assemblies 15 relative to the cross-section is from 0.1 mm to 3 mm; and/or a length of a projected shape of the insulating base 14 relative to the cross-section is from 0.3 mm to 5 mm; and/or a width of a projected shape of the insulating base 14 relative to the cross-section is from 0.05 mm to 0.5 mm.

The distance between adjacent transmission lines 13 falling within the range of 1 mm to 3 mm ensures a moderate distance between the transmission lines 13, avoiding electrical interference caused by being too close and increased wiring complexity caused by being too far. An appropriate spacing can reduce electromagnetic interference between different transmission lines 13 and improve the stability of signal transmission. A reasonable spacing makes wiring more convenient and reduces the complexity of wiring and manufacturing difficulty. An appropriate spacing can increase air circulation, help heat dissipation and prevent local overheating caused by overly dense transmission lines 13.

The diameter of the cable 10 falling within the range of 0.3 mm to 1 mm ensures a moderate overall diameter of the cable 10, which is not too thick to affect aesthetics and flexibility, nor too thin to affect electrical performance and mechanical strength. A smaller diameter makes the cable 10 look slimmer and more beautiful, suitable for scenarios with high decorative and design requirements. A smaller diameter makes the cable 10 more flexible, convenient for arrangement and installation in a narrow space. Within a reasonable range, the diameter of the cable 10 can ensure sufficient conductive capacity and signal transmission performance. An appropriate diameter can ensure the mechanical strength of the cable 10 and prevent damage caused by bending or pulling during use.

The distance between the light-emitting assemblies 15 and the transmission lines 13 falling within the range of 1 to 2.5 mm ensures an appropriate spacing between the light-emitting assemblies 15 and the transmission lines 13, avoiding electrical interference and thermal effects, and ensuring the reliability of connection at the same time. An appropriate spacing can reduce electromagnetic interference between the light-emitting assemblies 15 and the transmission lines 13 and improve the stability of signal transmission. An appropriate spacing can increase air circulation, help heat dissipation and prevent local overheating caused by being too close. A reasonable spacing can ensure the reliability of connection and prevent poor connection or short circuit caused by being too close or too far.

The length of the projected shape of the light-emitting assemblies 15 on the cross-section of the cable 10 falling within the range of 0.1 mm to 3 mm ensures a moderate length of the light-emitting assemblies 15, which is not too long to occupy too much space, nor too short to affect the light-emitting effect and heat dissipation performance. An appropriate length makes the light-emitting assemblies 15 more compact, saves the internal space of the cable 10 and is convenient for arrangement and installation. A reasonable length can ensure a good light-emitting effect to meet the demands of different application scenarios. An appropriate length can increase the heat dissipation area, help the light-emitting assemblies 15 dissipate heat and prolong their service life.

The width of the projected shape of the light-emitting assemblies 15 relative to the cross-section falling within the range of 0.1 mm to 3 mm ensures a moderate width of the light-emitting assemblies 15, which is not too wide to affect the flexibility and aesthetics of the cable 10, nor too narrow to affect the light-emitting effect and mechanical strength. A smaller width makes the cable 10 look slimmer and more beautiful, meeting the modern aesthetic requirements. A smaller width can improve the flexibility of the cable 10, convenient for arrangement and installation in a narrow space. Within a reasonable range, the width of the light-emitting assemblies 15 can ensure a good light-emitting effect and uniform light distribution. An appropriate width can ensure the mechanical strength of the light-emitting assemblies 15 and prevent damage caused by collision or extrusion during use.

The length of the projected shape of the insulating base 14 relative to the cross-section falling within the range of 0.3 mm to 5 mm ensures a moderate length of the insulating base 14, which is not too long to affect the overall size and aesthetics of the cable 10, nor too short to affect electrical safety and heat dissipation performance. An appropriate length can provide sufficient insulation protection, prevent electrical short circuit and electric leakage, and ensure the safety of users' use. A longer insulating base 14 can increase the heat dissipation area, help the light-emitting assemblies 15 dissipate heat and prolong their service life. Within a reasonable range, the length of the insulating base 14 can ensure the compactness of the internal structure of the cable 10 and save space. An appropriate length can make the insulating base 14 and the light-emitting assemblies 15 coordinated, improving the overall aesthetics of the cable 10.

The width of the projected shape of the insulating base 14 relative to the cross-section falling within the range of 0.05 mm to 0.5 mm ensures a moderate width of the insulating base 14, which is not too wide to affect the flexibility and aesthetics of the cable 10, nor too narrow to affect electrical safety and mechanical strength. An appropriate width can provide sufficient insulation protection, prevent electrical short circuit and electric leakage, and ensure the safety of users' use. A smaller width can improve the flexibility of the cable 10, convenient for arrangement and installation in a narrow space. An appropriate width can ensure the mechanical strength of the insulating base 14 and prevent damage caused by external forces during use.

In summary, in the above design of the cable 10, setting the ranges of the distance between adjacent transmission lines 13, the diameter of the cable 10, the distance between the light-emitting assemblies 15 and the transmission lines 13, the length and width of the light-emitting assemblies 15, and the length and width of the insulating base 14 can bring the following beneficial effects in many aspects: 1. Reducing electromagnetic interference and improving the stability of signal transmission. 2. Optimizing space utilization, saving internal space and facilitating arrangement and installation. 3. Improving the heat dissipation effect and prolonging the service life of the light-emitting assemblies 15 and the cable 10. 4. Enhancing structural stability and improving the mechanical strength and reliability of the cable 10. 5. Improving electrical safety, preventing short circuit and electric leakage and ensuring the safety of users' use. 6. Enhancing aesthetics and improving the visual effect and attractiveness of the cable 10. 7. Improving manufacturing efficiency, simplifying the production process and reducing manufacturing costs. 8. Facilitating maintenance and detection and improving the efficiency and convenience of maintenance and detection. 9. Improving design flexibility and adapting to a variety of application scenarios and design requirements.

This multi-parameter optimized design not only improves the performance of the cable 10 in terms of functionality, but also provides more convenience and optimization in the production, use and maintenance processes, meeting users' demands for high-quality light-emitting cables 10.

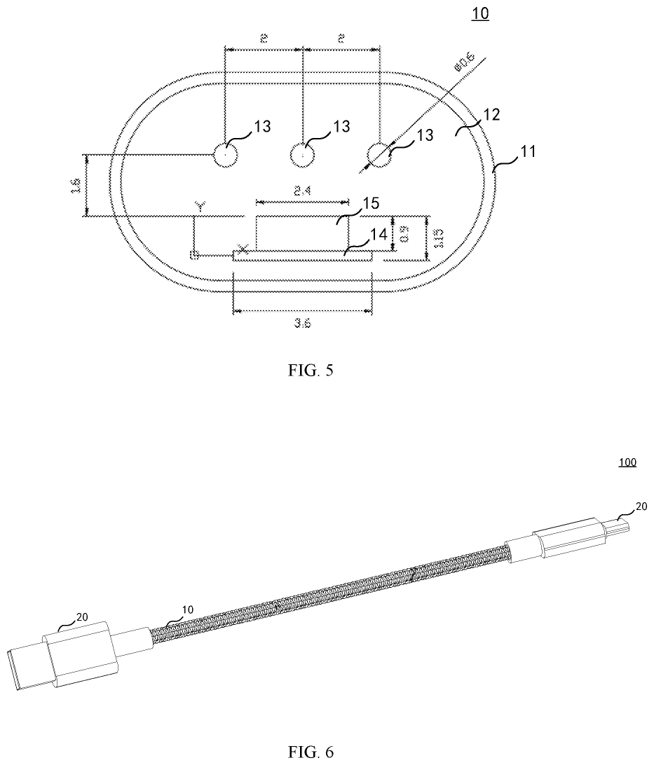

In some embodiments, please refer to FIG. 5, the distance between adjacent transmission lines 13 is 2 mm, the diameter of the cable 10 is 0.6 mm, the distance between the light-emitting assemblies 15 and the transmission lines 13 is 1.6 mm, the length of the projected shape of the light-emitting assemblies 15 on the cross-section of the cable 10 is 2.4 mm, the width of the projected shape of the light-emitting assemblies 15 relative to the cross-section is 0.9 mm, the length of the projected shape of the insulating base 14 relative to the cross-section is 3.6 mm, and the width of the projected shape of the insulating base 14 relative to the cross-section is 0.25mm (1.15−0.9).

With reference to FIG. 6, the present application provides a data line 100, including the cable 10 provided in any embodiment of the present application and an adapter interface 20; in which the adapter interface 20 is connected to the transmission lines 13 and the light-emitting assemblies 15 of the cable 10.

The present application provides a design of a data line 100 with a light-emitting function. By optimizing the layout of the light-emitting assemblies 15 and the transmission lines 13 in the cable 10 part and the standardization and function expansion of the adapter interface 20, multiple beneficial effects are brought. Specifically, it includes improving data transmission speed, enhancing the controllability of the light-emitting effect, improving overall safety, optimizing heat dissipation performance, improving aesthetics, enhancing mechanical strength, improving user-friendliness, simplifying the manufacturing process and improving the convenience of maintenance and detection. This design not only improves the performance and reliability of the product, but also provides more convenience and optimization in the production, use and maintenance processes, meeting users' demands for high-quality and multi-functional data lines 100.

At the same time, the type of the adapter interface is adapted to the data line, which can be realized with any type of data line, and the embodiments of the present application do not limit the type of the data line and the type of the adapter interface.

The present application provides a cable and a data line, aiming to solve the problem that most of the light-emitting data cables on the market have technical limitations despite being able to achieve a certain light-emitting effect. For example, the light-emitting elements of many cables can emit light on one side or the light distribution is uneven, resulting in poor light-emitting effect and failure to present an ideal visual effect from all angles. In addition, the design of some cables does not fully consider the problems of energy consumption and heat dissipation, leading to shortened service life and potential safety hazards of the cables. When the provided cable is applied to a data line, it can achieve high-brightness light emission without dead angles in 360 degrees, and can also achieve various personalized light-emitting effects.

The cable provided by the present application has at least the following beneficial effects: 1. 360-degree dead-angle-free light emission, through the design of the light-emitting adhesive layer and the covering layer, light can be evenly distributed to all directions of the cable, realizing high-brightness light emission without dead angles in 360 degrees. This design enables the cable to present an ideal visual effect from any viewing angle, solving the problem of uneven light distribution of traditional light-emitting data lines. 2. Personalized light-emitting effects, due to the combined design of the light-emitting adhesive layer and the light-homogenizing material, users can adjust the light color and brightness of the light-emitting assemblies according to demands, achieving various personalized light-emitting effects. This flexibility makes the cable not only a data transmission tool, but also a fashionable ornament, meeting the personalized demands of users. 3. Optimization of energy consumption and heat dissipation, by optimizing the arrangement of the light-emitting assemblies and the selection of materials, energy consumption is reduced, and at the same time, through the design of the insulating base, heat generation is effectively managed and dispersed, reducing the temperature of the cable. This design prolongs the service life of the cable, reduces faults and potential safety hazards caused by overheating, and improves the reliability and safety of the product. 4. Enhanced light diffuse reflection effect, the surface design of the transmission lines is conducive to the diffuse reflection of light, further enhancing the light-emitting effect. This design not only improves the utilization rate of light, but also makes the light-emitting effect of the cable more uniform and bright, enhancing the user's visual experience.

In summary, through the ingenious design and technical application, the cable not only solves multiple problems existing in traditional light-emitting data lines, but also provides a better light-emitting effect and higher safety and reliability, having significant technological progress and market application prospects.

In the description of the present application, it should be noted that the terms “installation”, “connection” and “connection” should be understood in a broad sense unless otherwise clearly specified and limited, for example, it can be a fixed connection, a detachable connection or an integral connection; it can be a mechanical connection or an electrical connection; it can be a direct connection or an indirect connection through an intermediate medium, and it can be the internal communication between two elements or the interaction relationship between two elements. For those of ordinary skill in the art, the specific meanings of the above terms in the present application can be understood according to specific situations.

In the present application, unless otherwise explicitly specified and limited, a first feature being “on” or “under” a second feature may include direct contact between the first and second features, and may also include the first and second features not being in direct contact but being in contact via another feature interposed between them. Furthermore, a first feature being “on”, “above” or “on the top of” a second feature includes the first feature being directly above and obliquely above the second feature, or merely indicates that the horizontal height of the first feature is higher than that of the second feature. A first feature being “under”, “below” or “on the bottom of” a second feature includes the first feature being directly below and obliquely below the second feature, or merely indicates that the horizontal height of the first feature is lower than that of the second feature.

The disclosure above provides numerous different embodiments or examples for implementing different structures of the present application. To simplify the disclosure of the present application, the descriptions of components and arrangements of specific examples are provided above. Of course, these are merely examples and are not intended to limit the present application. In addition, the present application may repeat reference numerals and/or reference letters in different examples, and such repetition is for the purpose of simplification and clarity, and does not in itself indicate a relationship between the various embodiments and/or arrangements discussed. In addition, the present application provides examples of various specific processes and materials, but those of ordinary skill in the art will recognize the applicability of other processes and/or the use of other materials.

In the description of this specification, references to the terms “one embodiment”, “some embodiments”, “schematic embodiment”, “example”, “specific example”, or “some examples” and the like mean that a specific feature, structure, material, or characteristic described in connection with the embodiment or example is included in at least one embodiment or example of the present application. In this specification, schematic references to the above terms do not necessarily refer to the same embodiment or example. Moreover, the specific features, structures, materials, or characteristics described may be combined in any suitable manner in any one or more embodiments or examples.

What is claimed is:

1. A cable, comprising:
a light-emitting adhesive layer, wherein the light-emitting adhesive layer has a first accommodating region and a second accommodating region disposed opposite each other;
a covering layer, wherein the covering layer is disposed on an outer side of the light-emitting adhesive layer, and the covering layer is made of a light-homogenizing material;
a plurality of transmission lines, wherein the plurality of transmission lines are arranged at intervals in the first accommodating region of the light-emitting adhesive layer, and each transmission line is either a power line or a communication line;
an insulating base, wherein the insulating base comprises a first end surface and a second end surface disposed opposite each other, the first end surface faces the transmission lines, and the insulating base is disposed in the second accommodating region;
a plurality of light-emitting assemblies, wherein the plurality of light-emitting assemblies are arranged one by one on the second end surface of the insulating base along the extending direction of the cable and are located in the second accommodating region; light emitted by the light-emitting assemblies passes through the light-emitting adhesive layer and the covering layer;
wherein the light emitted by the light-emitting assemblies is diffusely reflected by the transmission lines to form diffusely reflected light, and the diffusely reflected light is emitted through the light-emitting adhesive layer and the covering layer which face the second end surface of the insulating base.

2. The cable according to claim 1, wherein the transmission lines are partially wrapped in the light-emitting adhesive layer, or the transmission lines are completely wrapped in the light-emitting adhesive layer; and/or
the insulating base together with pins and the light-emitting assemblies disposed on the insulating base is partially wrapped in the light-emitting adhesive layer, or the insulating base together with the pins and the light-emitting assemblies disposed on the insulating base is completely wrapped in the light-emitting adhesive layer.

3. The cable according to claim 1, wherein a projected shape of the first accommodating region on a cross-section of the cable is any one of a circle, a rectangle, an ellipse, a trapezoid, a triangle and a rhombus; and/or
a projected shape of the second accommodating region on the cross-section of the cable is any one of a circle, a rectangle, an ellipse, a trapezoid, a triangle and a rhombus;
wherein the cross-section is a plane perpendicular to the extending direction of the cable.

4. The cable according to claim 1, wherein a projected shape of the first accommodating region on a cross-section of the cable is the same as a projected shape of the transmission lines on the cross-section of the cable.

5. The cable according to claim 1, wherein the plurality of transmission lines are arranged at equal intervals in the first accommodating region.

6. The cable according to claim 1, wherein the first accommodating region comprises a plurality of first sub-accommodating regions, and each first sub-accommodating region is configured to place one transmission line.

7. The cable according to claim 1, wherein the second accommodating region comprises: a second sub-accommodating region and a third sub-accommodating region;
wherein the second sub-accommodating region is in communication with the third sub-accommodating region, the insulating base is disposed in the second sub-accommodating region, and the light-emitting assemblies on the insulating base are disposed in the third sub-accommodating region.

8. The cable according to claim 7, wherein an area of a projected shape of the second sub-accommodating region on a cross-section of the cable is greater than or equal to an area of a projected shape of the insulating base on the cross-section of the cable; and an area of a projected shape of the third sub-accommodating region on the cross-section of the cable is greater than or equal to an area of a projected shape of the light-emitting assemblies on the cross-section of the cable.

9. The cable according to claim 1, wherein a distance between the light-emitting assemblies and the light-emitting adhesive layer is a preset distance; wherein the smaller the preset distance is, the more light-emitting assemblies are provided per meter of the cable.

10. The cable according to claim 9, wherein the preset distance is from 1 to 30 mm; and/or
if the preset distance is a first distance, the number of the light-emitting assemblies per meter of the cable is greater than a first preset number; and
if the preset distance is a second distance, the number of the light-emitting assemblies per meter of the cable is greater than a second preset number; and
if the preset distance is a third distance, a predetermined relationship exists between the number of the light-emitting assemblies and the length of the cable;
wherein the first distance is smaller than the second distance, the second distance is smaller than the third distance, the first preset number is greater than the second preset number, and the second preset number is greater than the third preset number.

11. The cable according to claim 10, wherein the first distance is from 1 to 10 mm, and the first preset number is 100; the second distance is from 10 to 13 mm, and the second preset number is 80; the third distance is from 13 to 30 mm, and the third preset number is 50.

12. The cable according to claim 1, wherein the covering layer comprises a light-homogenizing tube or a braided sleeve; the light-homogenizing tube is sleeved on the outer side of the light-emitting adhesive layer, or the light-homogenizing tube is wrapped on the outer side of the light-emitting adhesive layer through an injection molding process; the braided sleeve is wrapped on the outer side of the light-emitting adhesive layer; and/or
the number of the transmission lines is from 2 to 8.

13. The cable according to claim 1, wherein at least one light-emitting assembly is disposed on the second end surface of the insulating base, and light emitted by the light-emitting assemblies on the second end surface passes through the light-emitting adhesive layer and the covering layer which faces the second end surface of the insulating base.

14. The cable according to claim 1, wherein a light transmittance of the insulating base is greater than a preset light transmittance.

15. The cable according to claim 14, wherein a material of the insulating base is any one of sapphire, glass, polyimide film and polyethylene terephthalate film.

16. The cable according to claim 1, wherein each of the light-emitting assemblies comprises:
a pin, wherein the pin is disposed on the insulating base;
at least one light-emitting chip, wherein the light-emitting chip is disposed on the pin and connected to the pin;
a driving chip, wherein the driving chip is disposed on the pin, the driving chip is respectively connected to the light-emitting chip and the pin, and the driving chip is configured to control the light-emitting chip to emit light;
a packaging adhesive, wherein the packaging adhesive surrounds and encapsulates the light-emitting chip and the driving chip.

17. The cable according to claim 16, further comprising:
at least one light-emitting cluster, wherein each light-emitting cluster comprises one or more light-emitting assemblies;
wherein the one or more light-emitting assemblies in each light-emitting cluster are configured to share a common driving chip.

18. The cable according to claim 1, wherein a ratio of a width of a projected shape of the insulating base on a cross-section of the cable to a width of a projected shape of each light-emitting assembly on the cross-section of the cable falls within a preset range, and the preset range is from 1 to 1.2; and/or
the plurality of light-emitting assemblies are arranged at equal intervals on the insulating base.

19. The cable according to claim 1, wherein a distance between adjacent transmission lines is from 1 mm to 3 mm; and/or
a diameter of the cable is from 0.3 mm to 1 mm; and/or
a distance between the light-emitting assemblies and the transmission lines is from 1 to 2.5 mm; and/or
A length of a projected shape of the light-emitting assemblies on a cross-section of the cable is from 0.1 mm to 3 mm; and/or
a width of a projected shape of the light-emitting assemblies on the cross-section of the cable is from 0.1 mm to 3 mm; and/or
a length of a projected shape of the insulating base on the cross-section of the cable is from 0.3 mm to 5 mm; and/or
a width of a projected shape of the insulating base on the cross-section of the cable is from 0.05 mm to 0.5 mm.

20. A data line, comprising the cable according to claim 1 and an adapter interface;
wherein the adapter interface is connected to the transmission lines and the light-emitting assemblies of the cable.
